(19) United States
(12) Patent Application Publication
(10) Pub. No.: US 2024/0399910 A1
(43) Pub. Date: Dec. 5, 2024

(54) VEHICLE WIRELESS CHARGER

(71) Applicant: FORD GLOBAL TECHNOLOGIES, LLC, Dearborn, MI (US)

(72) Inventor: Michael John HARMON, Northville, MI (US)

(21) Appl. No.: 18/203,265

(22) Filed: May 30, 2023

(51) Int. Cl. B60L 53/38; B60L 53/12; B60L 53/36; B60L 53/66

(52) U.S. Cl. CPC B60L 53/38; B60L 53/12; B60L 53/36; B60L 53/66

(57) ABSTRACT

An automotive battery charger includes a controller that extends a pair of tire blocks relative to a housing and along ground to a location that is based on configuration information from a vehicle such that rotation of a fixed-length arm relative to the ground elevates a charge pad attached to an end thereof to a predetermined position such that the charge pad is aligned adjacent to a charge coil of the vehicle.

### TECHNICAL FIELD

The present disclosure relates to a wireless charger to charge an electric vehicle.

### BACKGROUND

Electric vehicles may be propelled by a traction battery supplying electric power to a motor. The traction battery may be recharged by a wired and/or wireless charger. In case of wireless charging, a vehicle pad may receive electromagnetic power transmitted from a charger pad to charge the traction battery.

### SUMMARY

A wireless automotive battery charger includes a housing, a pair of extendable tire blocks at least partially contained by the housing, a fixed-length arm disposed between the tire blocks and hingedly arranged with the housing, a charge pad hingedly mounted with the arm, and a controller. The controller, after receiving configuration information from a vehicle, extends the tire blocks relative to the housing and along ground to a location that is based on the configuration information such that rotation of the arm to a predetermined position elevates the charge pad relative to the ground and aligns the charge pad adjacent to a charge coil of the vehicle.

A method includes, responsive to receiving configuration information from a vehicle, extending tire blocks away from a housing and along ground to a location that is based on the configuration information such that rotation of an arm disposed between the tire blocks to a predetermined position elevates a charge pad relative to the ground and aligns the charge pad adjacent to a charge coil of the vehicle without altering a length of the arm.

An automotive battery charger includes a controller that extend a pair of tire blocks relative to a housing and along ground to a location that is based on configuration information from a vehicle, and after contact between tires of the vehicle and the tire blocks, rotates a fixed-length arm relative to the ground to elevate a charge pad attached to an end thereof to a predetermined position that is based on the configuration such that the charge pad is aligned adjacent to a charge coil of the vehicle.

### BRIEF DESCRIPTION OF THE DRAWINGS

FIG. 1 is a diagram of an electrified vehicle illustrating drivetrain and energy storage components including an electric machine.

FIG. 2 is a block topology of a vehicle charging system.

FIG. 3 is a diagram of a wireless charging device.

FIG. 4 is a diagram of parameters for determining the wireless charging device configuration.

FIG. 5 is a flow diagram for a process for preparing to charge a vehicle.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure, among other things, proposes a system for wirelessly charging an electric vehicle.

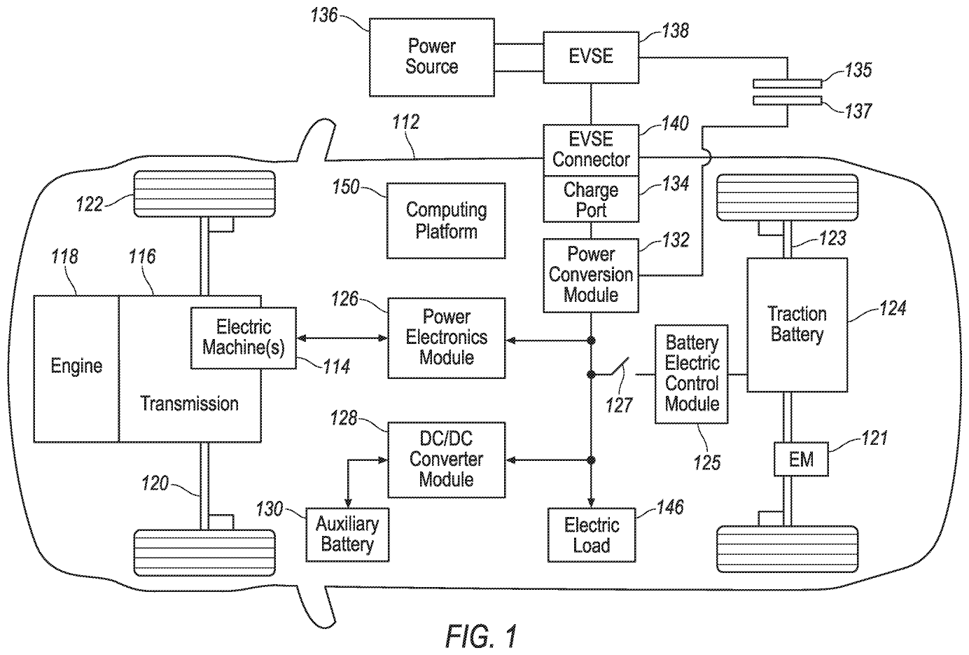

FIG. 1 illustrates a plug-in hybrid-electric vehicle (PHEV). A plug-in hybrid-electric vehicle 112 may comprise one or more electric machines (electric motors) 114 mechanically coupled to a hybrid transmission 116. The electric machines 114 may be capable of operating as a motor or a generator. In addition, the hybrid transmission 116 is mechanically coupled to an engine 118. The hybrid transmission 116 is also mechanically coupled to a drive shaft (e.g. a front drive shaft 120) that is mechanically coupled to the wheels 122. The electric machines 114 may provide propulsion and deceleration capability when the engine 118 is turned on or off. The electric machines 114 may also act as generators and may provide fuel economy benefits by recovering energy that would be lost as heat in the friction braking system. The electric machines 114 may also reduce vehicle emissions by allowing the engine 118 to operate at more efficient speeds and allowing the hybrid-electric vehicle 112 to be operated in electric mode with the engine 118 off under certain conditions. Additionally or alternatively, the vehicle 112 may be provided with a plurality of electric machines 114 configured to propel the front and rear wheels independently. For instance, a second electric machine 121 may be coupled to a rear drive shaft 123 and drive the rear wheels independently from the electric machine 114 driving the front wheels.

A traction battery or battery pack 124 stores energy that may be used by the electric machines 114. A vehicle battery pack 124 may provide a high voltage DC output. The traction battery 124 may be electrically coupled to one or more battery electric control modules (BECM) 125. The BECM 125 may be provided with one or more processors and software applications configured to monitor and control various operations of the traction battery 124. The traction battery 124 may be further electrically coupled to one or more power electronics modules 126. The power electronics module 126 may also be referred to as a power inverter. One or more contactors 127 may isolate the traction battery 124 and the BECM 125 from other components when opened and couple the traction battery 124 and the BECM 125 to other components when closed. The power electronics module 126 may also be electrically coupled to the electric machines 114 and provide the ability to bi-directionally transfer energy between the traction battery 124 and the electric machines 114. For example, a traction battery 124 may provide a DC voltage while the electric machines 114 may operate using a three-phase AC current. The power electronics module 126 may convert the DC voltage to a three-phase AC current for use by the electric machines 114. In a regenerative mode, the power electronics module 126 may convert the three-phase AC current from the electric machines 114 acting as generators to the DC voltage compatible with the traction battery 124. The description herein is equally applicable to a pure electric vehicle. For a pure electric vehicle, the hybrid transmission 116 may be a gear box connected to the electric machine 114 and the engine 118 may not be present.

In addition to providing energy for propulsion, the traction battery 124 may provide energy for other vehicle electrical systems. A vehicle may include a DC/DC converter module 128 that converts the high voltage DC output of the traction battery 124 to a low voltage DC supply that is compatible with other low-voltage vehicle loads. An output of the DC/DC converter module 128 may be electrically coupled to an auxiliary battery 130 (e.g., 12V battery).

The vehicle 112 may be a battery electric vehicle (BEV) or a plug-in hybrid electric vehicle (PHEV) in which the traction battery 124 may be recharged by an external power source 136. The external power source 136 may be a connection to an electrical outlet. The external power source 136 may be an electrical power distribution network or grid as provided by an electric utility company. The external power source 136 may be electrically coupled to electric vehicle supply equipment (EVSE) 138. The EVSE 138 may provide circuitry and controls to regulate and manage the transfer of energy between the power source 136 and the vehicle 112. The external power source 136 may provide DC or AC electric power to the EVSE 138. In one example, the vehicle 112 may be configured to receive the electric charge from the EVSE 138 via wired charging. In this case, the EVSE 138 may have a charge connector 140 for plugging into a charge port 134 of the vehicle 112. The charge port 134 may be any type of port configured to transfer power from the EVSE 138 to the vehicle 112. In an additional and/or alternative example, the vehicle 112 may be configured to receive the electric charge from the EVSE 138 via wireless charging. In this case, the wireless charging may be performed via inductive coupling between a charger pad 135 of the EVSE 138 and a vehicle pad 137 of the vehicle 112. During the wireless charging, an oscillating current may pass through a primary coil (transmit antenna) of the charger pad 135 (receive antenna) to generate an oscillating magnetic near-field that induces currents in a secondary coil of the vehicle pad 137 coupled to the charger pad 135. The vehicle pad 137 may be positioned at various locations on the vehicle 112. For instance, the vehicle pad 137 may be positioned at the bottom of the vehicle 112 to wirelessly couple with the charger pad 135 installed on a parking space.

The charge port 134 and the vehicle pad 137 may be electrically coupled to a charger or on-board power conversion module 132. The power conversion module 132 may condition the power supplied from the EVSE 138 to provide the proper voltage and current levels to the traction battery 124. The power conversion module 132 may interface with the EVSE 138 to coordinate the delivery of power to the vehicle 112.

One or more electrical loads 146 may be coupled to the high-voltage bus. The electrical loads 146 may have an associated controller that operates and controls the electrical loads 146 when appropriate. Examples of the electrical loads 146 may be a heating module, an air-conditioning module, or the like.

The various components discussed may have one or more associated controllers to control and monitor the operation of the components. The controllers may communicate via a serial bus (e.g., Controller Area Network (CAN)) or via discrete conductors. A computing platform 150 may be present to coordinate the operation of the various components. It is noted that the computing platform 150 is used as a general term and may include one or more controller devices configured to perform various operations in the present disclosure. The computing platform 150 individually or in combination with other components of the vehicle shown or not shown, may be programmed to perform various operations of the vehicle 112.

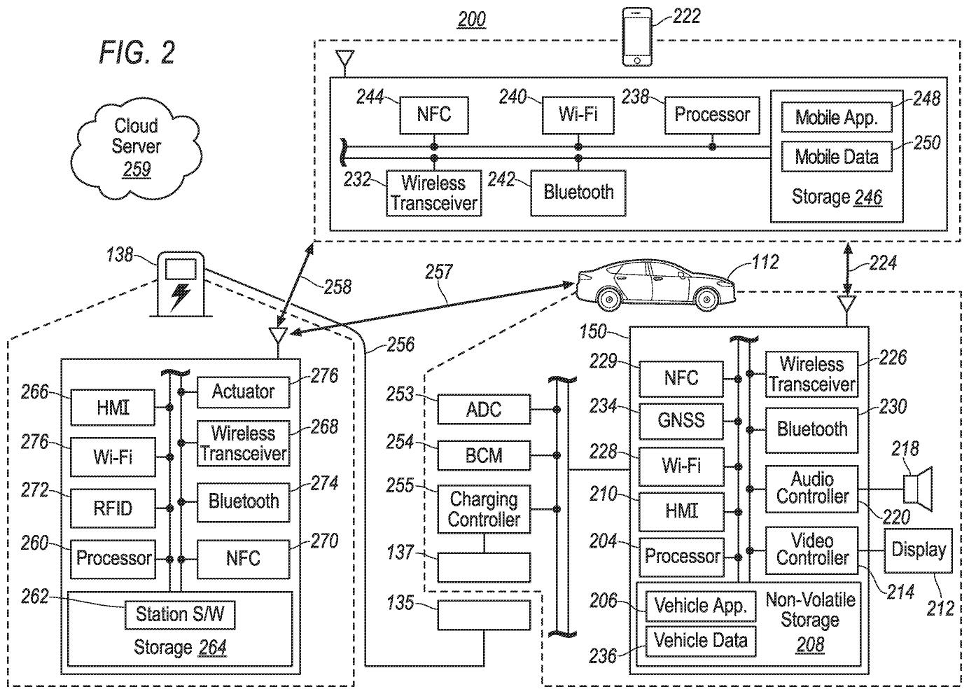

FIG. 2 is a block topology 200 of the vehicle charging system. A computing platform 150 of the vehicle 112 may include one or more processors 204 configured to perform instructions, commands, and other routines in support of the processes described herein. For instance, the computing platform 150 may be configured to execute instructions of vehicle applications 206 to provide features such as navigation, and charging control. Such instructions and other data may be maintained in a non-volatile manner using a variety of types of computer-readable storage medium 208. The computer-readable medium 208 (also referred to as a processor-readable medium or storage) includes any non-transitory medium (tangible medium) that participates in providing instructions or other data that may be read by the processor 204 of the computing platform 150. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and SQL.

The computing platform 150 may be provided with various features allowing the vehicle occupants/users to interface with the computing platform 150. For example, the computing platform 104 may receive input from human-machine interface (HMI) controls 210 configured to provide for occupant interaction with the vehicle 112. As an example, the computing platform 150 may interface with one or more buttons (not shown) or other HMI controls (e.g., steering wheel audio buttons, a push-to-talk button, instrument panel controls, etc.) configured to invoke functions on the computing platform 150 as well as other components of the vehicle 112.

The computing platform 150 may also drive or otherwise communicate with one or more displays 212 configured to provide visual output to vehicle occupants by way of a video controller 214. In some cases, the display 212 may be a touch screen further configured to receive user touch input via the video controller 214, while in other cases the display 212 may be a display only, without touch input capabilities. The computing platform 104 may also drive or otherwise communicate with one or more speakers 218 configured to provide audio output to vehicle occupants by way of an audio controller 220.

The computing platform 150 may be configured to communicate with a mobile device 222 of the vehicle user via a wireless connection 224. The mobile device 222 may be any of various types of portable computing device, such as cellular phones, tablet computers, smart watches, laptop computers, portable music players, key fobs, or other devices capable of communication with the computing platform 150. In many examples, the computing platform 150 may include a wireless transceiver 226 in communication with a Wi-Fi controller 228, a near-field controller (NFC) 229, a Bluetooth controller 230, and other controllers such as a Zigbee transceiver, an IrDA transceiver, an RFID transceiver (not shown), and configured to communicate with a compatible wireless transceiver 232 of the mobile device 222. The computing platform 150 may be further provided with location services via a global navigation satellite system (GNSS) controller 234 configured to determine the location of the vehicle 112 and plan navigation routes. For instance, the GNSS controller 234 may be configured to support the global positioning system (GPS) as an example. The navigation software may be stored in the non-volatile storage 208 as a part of the vehicle applications 206. The map data used for route planning may be also stored in the non-volatile storage 208 as a part of vehicle data 236.

The mobile device 222 may be provided with a processor 238 configured to perform instructions, commands, and other routines in support of the processes such as calling, wireless communication, multi-media processing and digital authentication. The wireless transceiver 232 of the mobile device 222 may be in communication with a Wi-Fi controller 240, a Bluetooth controller 242, an NFC controller 244, and other controllers configured to communicate with the compatible wireless transceiver 226 of the computing platform 150. The mobile device 222 may be provided with a non-volatile storage 246 configured to store various software and data. For instance, the non-volatile storage 246 may store mobile applications 248 and mobile data 250 to enable various features of the mobile device 222.

The computing platform 150 may be further configured to communicate with various electronic control units (ECUs) via one or more in-vehicle networks 254. The in-vehicle network 254 may include, but is not limited to, one or more of a controller area network (CAN), an Ethernet network, an ultra-wide band (UWB), and a media-oriented system transport (MOST), as some examples. The ECUs may include various controllers configured to perform various operations of the vehicle 112. For instance, the ECUs may include an autonomous driving controller (ADC) 253 configured to perform autonomous driving maneuvers in response to limited user inputs. The ECUs may further include a body control module (BCM) 254 configured to control body operations of the vehicle 112. For instance, if the vehicle 112 is provided with adjustable suspension features, the BCM 254 may be configured to adjust the height of the suspension at each wheel collectively and/or individually based on user setting. Additionally or alternatively, the BCM 254 may further adjust the suspension height based on usage scenarios. For instance, responsive to receiving a suspension adjustment request from the EVSE 138, the BCM 254 may adjust the suspension height of the corresponding wheel accordingly to facilitate wireless charging.

The ECUs may further include a charging controller 255 configured to control the charging of the vehicle battery 124. The charging controller 255 may be configured to communicate with the EVSE 138 to coordinate the vehicle charging via a wireless connection 257. Additionally or alternatively, the system may be configured to communicate the vehicle information to the EVSE 138 using the mobile device 222 through a wireless connection 258 with or without the involvement of the vehicle charging controller 255. The vehicle 112, the mobile device 222 and the EVSE 138 may be further configured to communicate with a cloud server 259 to obtain various information.

The EVSE 138 may include one or more processors 260 configured to perform instructions, commands, and other routines in support of the processes described herein. As an example, the EVSE 138 may be configured to execute instructions of station software 262 stored in a storage 264 to provide functions such as activating/deactivating charging, price selection, processing payment, and wireless communication with various digital entities. The EVSE 138 may be provided with HMI controls 266 configured to provide interaction with user.

The EVSE 138 may include a wireless transceiver 268 in communication with an NFC controller 270, a radio-frequency identification (RFID) controller 272, a Bluetooth controller 274 a Wi-Fi controller 276, and other controllers configured to communicate with compatible wireless transceiver 226 of the vehicle 112, and/or compatible wireless transceiver 232 of the mobile device 222.

The EVSE 138 may be further provided with one or more actuators 276 configured to operate one or more vehicle guiding and adjustment mechanism to facilitate wireless charging. As discussed above, the charge pad 135 may be placed flat on a parking space to wirelessly couple to the vehicle pad 137 located at the undercarriage of the vehicle 112. The charge pad 135 may be configured to wirelessly couple to a variety of compatible vehicles 112 having different suspension height and vehicle pad placements. For instance, an SUV may have a higher suspension for more ground clearance compared with a sedan. The different vehicle configurations may result in different vehicle pad placement all of which are configured to wirelessly couple to the charge pad 135. Although the EVSE wireless charging may be provided with tolerances to allow the wireless coupling within a predefined range, the charging speed and power may be negatively affected when the relative position between the vehicle pad 137 and the charge pad 135 are accurately aligned. For instance, the higher placement of the vehicle pad 137 on an SUV may increase the distance from the charge pad 135, reducing the charging efficiency. Therefore, the EVSE 138 may be provided with an adjustable wireless charging device to better accommodate different vehicle configurations.

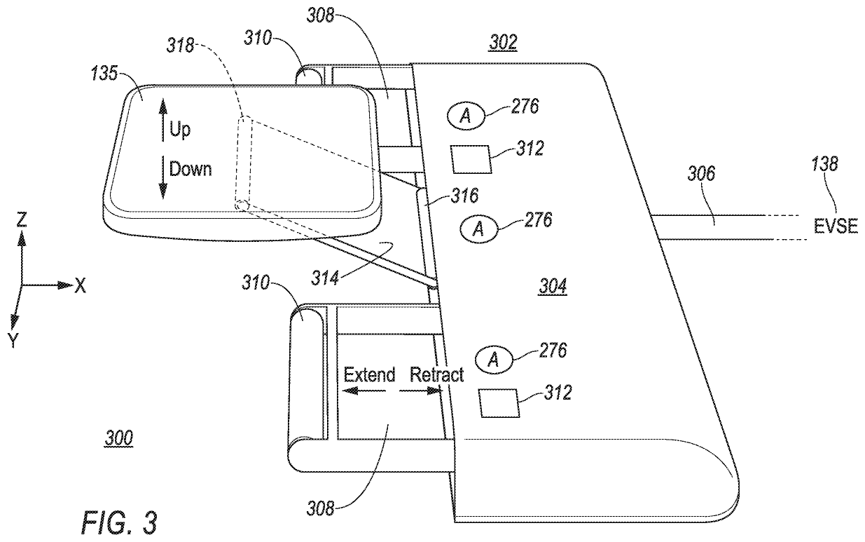

Referring to FIG. 3, a diagram 300 illustrating an example adjustable wireless charging device (charging device) 302 is illustrated. With continuing reference to FIGS. 1 and 2, the charging device 302 may be electrically connected to the EVSE 138 and configured to perform the wireless charging to the vehicle 112. The charging device 302 may include a base portion 304 electrically connected to the EVSE 138 via a cable 306. Alternatively, the charging device 302 may be implemented as a part of the EVSE 138. The base portion 304 may be implemented in a general rectangular shape with a cavity to accommodate various hardware mechanisms underneath a top cover.

The charging device 302 may further include two tire blocks 308 to engage with vehicle tires 122 on the same axle of the vehicle 112. The tire blocks 308 may be positioned on the same side of the base portion along a y-axis which corresponds to a transverse direction of the vehicle 112. The two tire blocks 308 may be separated at a distance approximately corresponding to the axle length of the vehicle 112. Each tire block 308 may be provided with an engaging portion 310 at the farther end configured to directly engage/touch the tire 122 of the vehicle 112. The engaging portion 310 may be provided with a width (e.g. 15 to 25 inches) to accommodate different axle lengths of different vehicles 112. During the operating state, the tire blocks 308 may extend from the base portion 304 in an x-axis direction which corresponds to a longitudinal direction toward the vehicle 112 to engage with the vehicle tires 122. The extension distance of the tire blocks 308 may be adjusted by one or more actuators 276 as coordinated by the EVSE 138 to adapt to various vehicle configurations. In the storage state, the tire blocks 308 may be fully or partially retracted into the base portion 304 such that the vehicle 112 may drive forward and backward without obstruction. The charging device 302 may detect the engagement between the tire blocks 308 and the vehicle tires via one or more sensors 312 in communication with the tire blocks 308. When the vehicle 112 pulls up at the parking spot and is properly parked at the charging device 302, the vehicle tires 122 may impose a forward pressure in the x-axis direction on the engaging portion 310 which pushes the tire blocks 308 toward the base portion 304. The forward pressure may be measured by the sensors 312 to detect the proper engagement with the vehicle tires 122.

The charging device 302 may further include a height adjustable charger pad 135 connected to the base portion via a height adjusting arm 314. The height adjusting arm 314 may include a first end attached to the base portion 304 via a first connector 316, and a second end attached to the charger pad 135 via a second connector 318. The height adjusting arm 314 may further include one or more cavities configured to accommodate electric cables and harnesses to facilitate the power transaction between the charger pad 135 and the vehicle 112. The height adjusting arm 314 may be configured to adjust the rising height between the charger pad 135 and ground in a z-axis direction via one or more actuators 276 to adapt to different vehicle heights. During the operating state, the charger pad 135 may risen to a designated height corresponding to the position of the vehicle 137 to facilitate the wireless charging. In the storage state, the charger pad 135 may be lowered to the ground level to minimize the chance to obstruct the vehicle driving. While the height adjusting arm 314 and the tire blocks 308 are operated collectively by the EVSE 138, the charging device 302 may provide guidance to vehicles of various configurations and allow accurate wireless coupling between the charger pad 135 and vehicle pad 137.

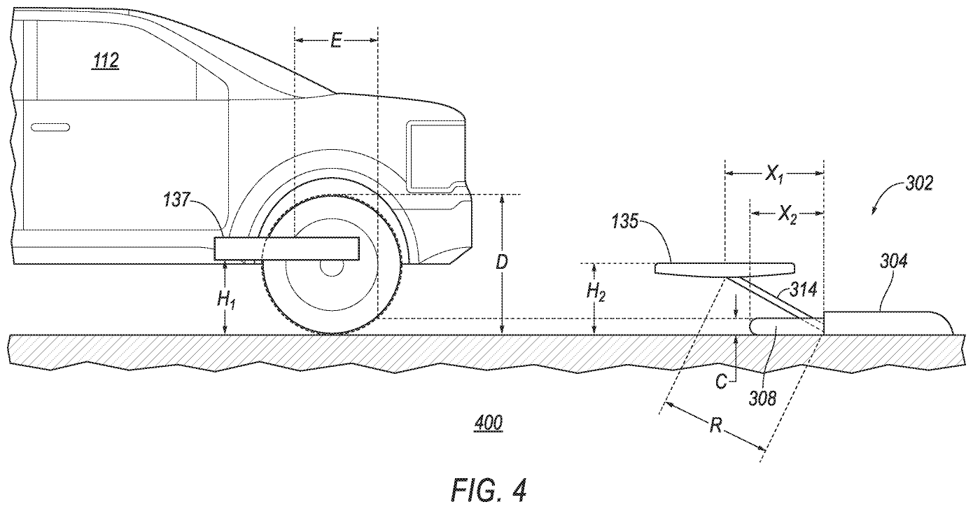

Referring to FIG. 4, an example diagram 400 of illustrating parameters for determining the tire blocks and charger pad positions of one embodiment of the present disclosure is shown. With continuing reference to FIGS. 1 to 3, the EVSE 138 may be configured to adjust tire blocks and charger pad positions of the charging device 302 to accommodate the physical configuration of the vehicle 112. As illustrated, the vehicle 112 may include a vehicle pad 137 located at the front end of the vehicle 112 approximately under the engine bay in the present example. The EVSE 138 may use the parameters of both the vehicle 112 and charging device 302 to determine the tire blocks and charger pad positions. More specifically, the height H₂ of the charging pad 135 in the z-axis direction may be determined using the following equation:

$${H}_{2} = {H}_{1} - T \qquad ( 1 )$$

wherein H₁ denotes a distance between a lower surface of the vehicle pad 137 and ground, and T denotes a tolerance representative of a gap required between the vehicle pad 137 and the charger pad 135 for optimal inductive coupling.

In addition, the extension length X₂ indicative of the distance the tire blocks 308 extend outside from the base portion 304 in the x-axis direction may be determined using the following equation:

$${X}_{2} = {X}_{1} - E + T \qquad ( 2 )$$

wherein E denotes the extension distance for the tire blocks 308 from the center of the vehicle pad 107 to a tire perimeter at a height C indicative of the height of the tire block (e.g. 4 inches). X₁ denotes the distance between the middle point of the charge pad 135 from the front edge of the base portion 304 in the x-axis direction. The distance X₁ may be determined using the following equation:

$${X}_{1} = \sqrt{{{R}_{1}}^{2} - {{H}_{1}}^{2}} \qquad ( 3 )$$

wherein R₁ denotes a length of the height adjusting arm 314 from the first end to the second end.

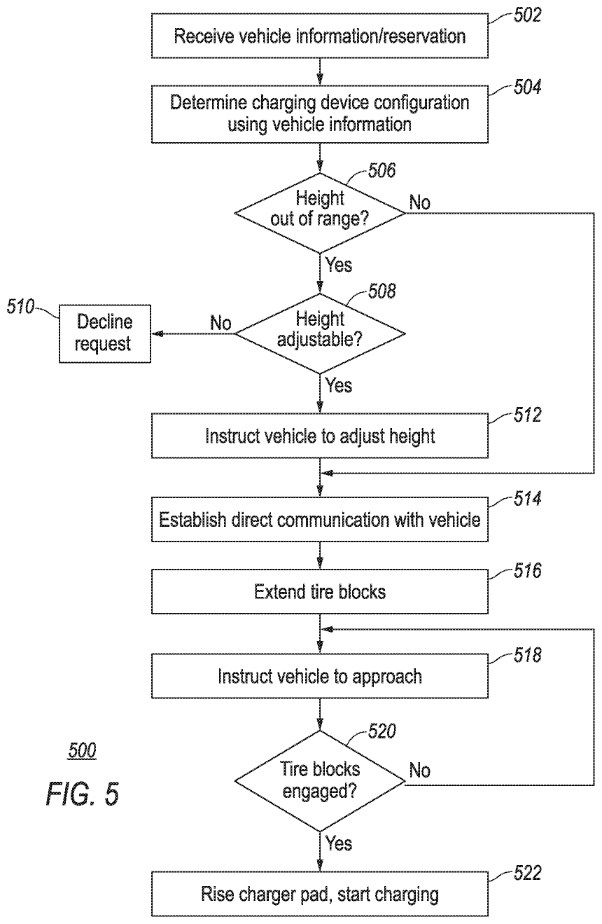

Referring to FIG. 5, an example flow diagram of a process 500 for configuring the wireless charging device of one embodiment of the present disclosure is illustrated. With continuing reference to FIGS. 1-4, the process 500 may be implemented via the EVSE 138. At operation 502, the EVSE 138 receives a charging request from a requesting vehicle 112 and/or the mobile device 222 associated with the requesting vehicle 112. The charging request may include various vehicle information related to the wireless charging. For instance, the charging request may include information related to physical configurations of the vehicle such as suspension height, location of the vehicle pad 135, tire size or the like. Additionally or alternatively, the charging request may include a vehicle make/model, and/or a vehicle identification (e.g. vehicle identification number (VIN)) which enables the EVSE 138 to obtain the physical configurations from the cloud server 259. The EVSE 138 may alternatively obtain the physical configurations of the vehicle 112 from the server if those are not directly provided in the charging request. The EVSE 138 may receive the charging request directly from the vehicle 112 and/or mobile device 222 via the wireless transceiver 268. Additionally or alternatively, the EVSE 138 may receive the charging request from the cloud server 25 as a charging reservation when the vehicle 112 is not yet in the vicinity of the EVSE 138. The reservation may further include additional information such as an anticipated arrival time to facilitate the charging schedule.

At operation 504, the EVSE 138 determines the configurations for the charging device 302 using the vehicle information received. As discussed previously with reference to FIG. 4, at least two aspects of the charging device configurations may be determined. First, the EVSE 138 may determine the extension length X₂ of the tire blocks 308 using the vehicle information received. The EVSE 138 may further determine the height H₂ of the charger pad 135 using the vehicle information received. Other configuration parameters may also be determined in different examples. For instance, the charging device 302 may be further provided with capabilities to adjust the position of the charger pad 135 transversely in the y-axis direction to accommodate vehicle configurations in which the vehicle pad 137 is placed off the transverse center of the vehicle.

Once the desired height H₂ of the charger pad 135 is determined, at operation 506, the EVSE 138 verifies if the desired height H₂ is beyond a designed elevating range of the charger pad 135. For instance, an off-road vehicle may have an increased suspension height making the vehicle pad 135 mounted on the under carriage too high beyond the reach of charging device 302. If the answer is yes, the process proceeds to operation 508 and the EVSE 138 determines if the suspension height of the requesting vehicle 112 is adjustable. Continuing with the above off-road vehicle example, the suspension of the off-road vehicle may be adjustable to accommodate various driving conditions. The suspension height may be increased to accommodate an off-road driving condition and decreased to accommodate city roads. If the vehicle suspension is at the increased height when the charging request is made, the height H₁ of the vehicle pad may be beyond the designed range of the charging device 302. If the EVSE 138 determines the vehicle suspension height is fixed and cannot be reduced, the process proceeds to operation 510 and the EVSE 138 declines the charging request from the requesting vehicle 112. Otherwise, if the EVSE 138 determines the suspension height of the vehicle is adjustable, the process proceeds to operation 512 and the EVSE 138 sends an instruction to adjust suspension height to the requesting vehicle 112. The instruction may include a target suspension configuration corresponding to a vehicle pad height H₁ that is within the designed range of the charging device 302.

At operation 514, responsive to the requesting vehicle 112 entering the vicinity of the EVSE 138, a direct wireless communication link 257 is established between the EVSE 138 and the requesting vehicle 112. This operation may be optional depending on the how the original charging request was received by the EVSE 138. For instance, the direct wireless communication may already have been established when the vehicle 112 sent the charging request. In this case, operation 514 may be unnecessary. Otherwise, if the vehicle 112 previously sent the charging request to the EVSE 138 via the cloud server 259, operation 514 may be performed to facilitate subsequent operations of the process 500.

At operation 516, the EVSE 138 extends the tire blocks 308 of the charging device 302 to the designated extension length X₂ by operating the one or more actuators 276. Responsive to a successful extension of the tire blocks 308, at operation 518, the EVSE 138 instructs the vehicle 112 to approach at the charging device 302 via the wireless link 257. In one example, the instruction may be transmitted to the requesting vehicle 112 as autonomous driving instructions if the ADC is available to the vehicle 112. The vehicle 112 may approach and park at the charging device 302 in an autonomous manner fully or partially without driving input.

At operation 520, the EVSE 138 verifies if the tires of the requesting vehicle 112 have engaged with the tire blocks 308 indicative of successful parking at the designated location. As discussed above, the sensors 312 may detect a pressure toward the base portion 304 caused by the vehicle tires 122 pressing the engaging portion 310 of the tire blocks 308. Once the pressure is detected indicative of successful parking, the process proceeds to operation 522 and the EVSE 138 elevates the arm 314 of the charging device 302 to raise the charger pad 135 to the designated height H₂. Responsive to detecting a successful wireless coupling between the charger pad 135 and the vehicle pad 137, the EVSE 138 starts to charge the vehicle 112.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words processor and processors may be interchanged herein, as may the words controller and controllers.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A wireless automotive battery charger comprising:
a housing;
a pair of extendable tire blocks at least partially contained by the housing;
a fixed-length arm disposed between the tire blocks and hingedly arranged with the housing;
a charge pad hingedly mounted with the arm; and
a controller programmed to, after receiving configuration information from a vehicle, extend the tire blocks relative to the housing and along ground to a location that is based on the configuration information such that rotation of the arm to a predetermined position elevates the charge pad relative to the ground and aligns the charge pad adjacent to a charge coil of the vehicle.

2. The battery charger of claim 1, wherein the controller is further programmed to, after contact between tires of the vehicle and the tire blocks that prevents the vehicle from further moving towards the housing, rotate the arm to the predetermined position.

3. The battery charge of claim 2, wherein the controller is further programmed to, after the extending and before the rotating, instruct the vehicle to move towards the housing.

4. The battery charger of claim 2, wherein the controllers is further programmed to, after completion of charge, retract the tire blocks toward the housing and rotate the arm towards the ground.

5. The battery charger of claim 1, wherein the charge pad is hingedly mounted with the arm such that the charge pad remains parallel to the ground during rotation of the arm.

6. The battery charger of claim 1, wherein the configuration information includes ride height of the vehicle.

7. The battery charger of claim 1, wherein the predetermined position is based on the configuration information.

8. A method comprising:
responsive to receiving configuration information from a vehicle, extending tire blocks away from a housing and along ground to a location that is based on the configuration information such that rotation of an arm disposed between the tire blocks to a predetermined position elevates a charge pad relative to the ground and aligns the charge pad adjacent to a charge coil of the vehicle without altering a length of the arm.

9. The method of claim 8 further comprising, responsive to contact between tires of the vehicle and the tire blocks that prevents the vehicle from further moving towards the housing, rotating the arm to the predetermined position.

10. The method of claim 9, after the extending and before the rotating, instructing the vehicle to move towards the housing.

11. The method of claim 8 further comprising, responsive to completion of charge, retracting the tire blocks toward the housing and rotating the arm towards the ground.

12. The method of claim 8, wherein the configuration information includes ride height of the vehicle.

13. The method of claim 8, wherein the predetermined position is based on the configuration information.

14. An automotive battery charger comprising:
a controller programmed to extend a pair of tire blocks relative to a housing and along ground to a location that is based on configuration information from a vehicle, and after contact between tires of the vehicle and the tire blocks, rotate a fixed-length arm relative to the ground to elevate a charge pad attached to an end thereof to a predetermined position that is based on the configuration such that the charge pad is aligned adjacent to a charge coil of the vehicle.

15. The battery charger of claim 14, wherein the controller is further programmed to, after the extending and before the rotating, instruct the vehicle to move toward the housing.

16. The battery charger of claim 14, wherein the controller is further programmed to, after completion of charge, retract the tire blocks toward the housing and rotate the arm towards the ground.

17. The battery charger of claim 14, wherein the configuration information including ride height of the vehicle.
